(19) United States
(12) Patent Application Publication
(10) Pub. No.: US 2018/0293438 A1
(43) Pub. Date: Oct. 11, 2018

(54) Creation of Digital Representations of Well Schematics

(71) Applicant: Halliburton Energy Services, Inc., Houston, TX (US)

(72) Inventors: Thomas Manuel Ortiz, Houston, TX (US); Olivier Roger Germain, Houston, TX (US)

(21) Appl. No.: 15/765,375

(22) PCT Filed: Dec. 2, 2015
(86) PCT No.: PCT/US2015/063493

§ 371 Date: Apr. 2, 2018

(51) Int. Cl. G06K 9/00; G06F 17/27; G06F 17/30; G06F 17/22; G06F 17/15

(52) U.S. Cl. CPC G06K 9/00476; G06K 9/00463; G06F 17/27; G06F 17/15; G06F 17/30985; G06F 17/2235; G06F 17/30247

(57) ABSTRACT

An example method of providing a digital representation of a well schematic includes storing a set of text strings and a set of image regions into a coordinate map. The method includes associating one or more text strings with one or more image regions. A text string is associated with an image region based on a context of the text string in the coordinate map. The method further includes linking one or more image regions with a corresponding catalogued image stored in a component database. The catalogued image represents a well schematic component. The method also includes generating a well schematic topology in accordance with the coordinate map and the one or more catalogued images linked with the one or more image regions. The method further includes updating the well schematic topology in accordance with one or more business rules.

### FIELD

The present disclosure relates generally to the field of well visualization and more particularly to the generation of schematics for existing wells utilizing disparate sources of information.

### BACKGROUND

A schematic of an existing well is an informative layout drawing of the components that comprise the well that may be used to make decisions related to the well. Such a schematic of a well, however, may be inaccurate due to various factors. For example, the well schematic may be incomplete, failing to provide all desired information related to a well. Likewise, the well schematic may be inaccurate. For example, various equipment in a well may have been replaced over time, but not reflected in the well schematic. Additionally, components associated with an existing well may change with time. For example, wear or the environment in which a wellbore tool is used may weaken, erode or otherwise alter a physical characteristic of the tool such that a well schematic generated for a newly completed well may be different than a well schematic of the same well after it has been in production for a period of time.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements. The drawing in which an element first appears is generally indicated by the left-most digit in the corresponding reference number.

FIG. 1 illustrates a block diagram of an exemplary computer system for aiding the creation of digital representations of printed well schematics in accordance with one or more embodiments of the present disclosure.

FIG. 2 illustrates an example of data stored in a component database in accordance with one or more embodiments of the present disclosure.

FIG. 3 illustrates a process flow of generating a well schematic topology based on one or more source documents in accordance with one or more embodiments of the present disclosure.

FIG. 4 illustrates an example of a source document in accordance with one or more embodiments of the present disclosure.

FIG. 5 illustrates an example of a coordinate map in accordance with one or more embodiments of the present disclosure.

FIG. 6 illustrates an example of a two-column data table that is produced by a context engine in accordance with one or more embodiments of the present disclosure.

FIG. 7 illustrates a block diagram of the context engine collecting information from multiple coordinate maps and generating a well schematic topology based on a plurality of coordinate maps and data stored in the component database.

FIG. 8 is a process flowchart of an exemplary method of providing a digital representation of a well schematic in accordance with one or more embodiments.

FIG. 9 is a process flowchart of an exemplary method of providing a digital representation of a well schematic in accordance with one or more embodiments.

FIG. 10 is a process flowchart of an exemplary method of storing a component identifier (ID) in a coordinate map in accordance with one or more embodiments.

FIG. 11 is a process flowchart of an exemplary method of linking a well schematic component to associated product data in accordance with one or more embodiments.

FIG. 12 is a block diagram of an exemplary computer system in which embodiments may be implemented.

### DETAILED DESCRIPTION OF THE INVENTION

Illustrative embodiments and related methodologies of the present disclosure are described below as they might be employed in a computer system for aiding the creation of digital representations of printed well schematics. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the interest of clarity, not all features of an actual implementation or methodology are described in this specification. It will be appreciated that in the development of any such actual implementation, numerous implementation-specific decisions must be made to achieve the developers' specific goals, such as compliance with system-related and business-related constraints, which will vary from one implementation to another. Further, when a particular feature, structure, or characteristic is described in connection with an embodiment, it is submitted that it would be within the knowledge of one skilled in the relevant art to effect such feature, structure, or characteristic in connection with other embodiments whether or not explicitly described.

Also, it would be apparent to one skilled in the relevant art that the embodiments of the present disclosure can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein. Further aspects and advantages of the various embodiments and related methodologies of this disclosure will become apparent from consideration of the following description and drawings.

Additionally, the foregoing disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper,” “uphole,” “downhole,” “upstream,” “downstream,” and the like, may be used herein for ease of description to describe one element or feature's relationship to another element(s) or feature(s) as illustrated in the Figures. The spatially relative terms are intended to encompass different orientations of the apparatus in use or operation in addition to the orientation depicted in the Figures. For example, if the apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

The present disclosure provides techniques to automate the process of producing detailed, up-to-date well schematics of existing wells from various printed source documents, such as older versions of the well schematics. Generally, a source document having text, images or both is digitized. Text strings are identified in a coordinate map while images are defined as image patterns. The text strings may be associated with a particular image pattern. Each image pattern and its associated text strings are then compared to a wellbore component database to determine which wellbore component the image pattern best matches. Based on a match, the wellbore component is then associated with the coordinate map previously generated. With all image patterns processed, a schematic topology is generated. In one or more embodiments, the schematic topology is refined to reflect wellbore design best practices. Thereafter, for one or more components in the refined wellbore topology, to the extent that such components are tools or other equipment in the wellbore, a product database may be searched to select the most desirable component of a particular type from a group of components of that same type. Finally, a well schematic for a particular point in time may be generated. The generated well schematic may reflect the most likely well schematic for that point in time.

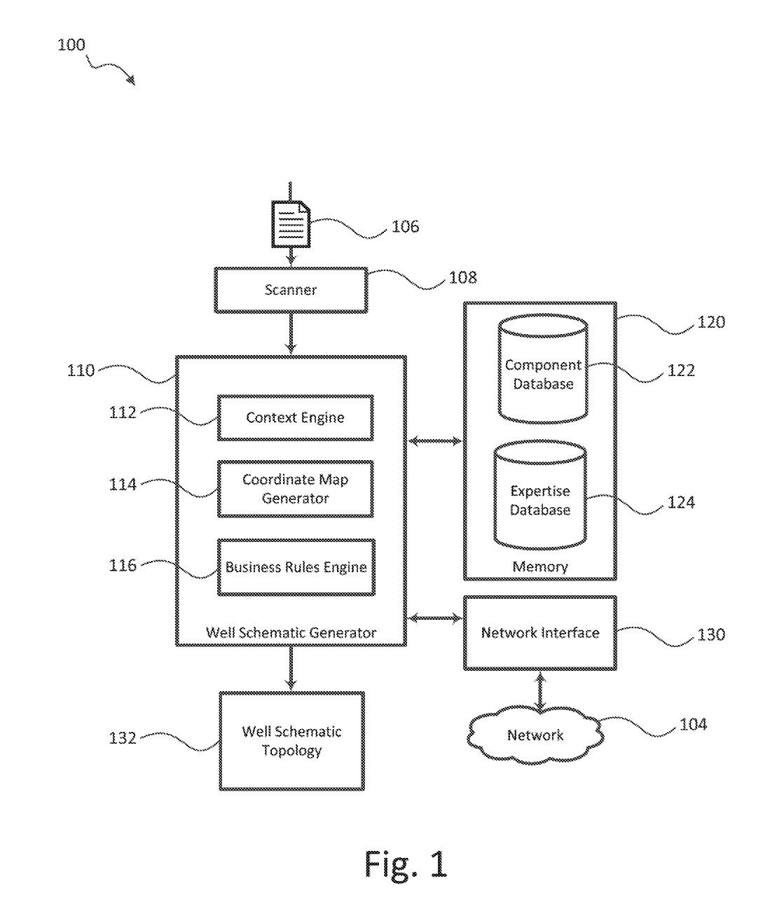

FIG. 1 illustrates a block diagram of an exemplary computer system 100 for aiding the creation of digital representations of printed well schematics in accordance with one or more embodiments of the present disclosure. As shown in FIG. 1, system 100 includes a well schematic generator 110, a memory 120, and a network interface 130 so as to enable a source document 106 associated with an existing well to be utilized to generate a well schematic topology 132. Well schematic generator 110 includes a context engine 112, coordinate map generator 114, and business rules engine 116. Memory 120 may be used to store a component database 122 and an expertise database 124. In an embodiment, well schematic generator 110 and its components (context engine 112, coordinate map generator 114, and business rules engine 116), memory 120, and network interface 130 may be communicatively coupled to one another via, for example, an internal bus of system 100.

In an embodiment, system 100 can be implemented using any type of computing device having one or more processors, a user input (for example, a mouse, QWERTY keyboard, touch-screen, a graphics tablet, or microphone), and a communications infrastructure capable of receiving and transmitting data over a network. Such a computing device can be, for example and without limitation, a mobile phone, a personal digital assistant (PDA), a tablet computer, a laptop computer, a desktop computer, a workstation, a cluster of computers, a set-top box, or other similar type of device capable of processing instructions and receiving and transmitting data to and from humans and other computing devices.

Well schematic generator 110 and its modules (context engine 112, coordinate map generator 114, and business rules engine 116) can be implemented in software, firmware, hardware, or any combination thereof. Furthermore, embodiments of context engine 112, coordinate map generator 114, and business rules engine 116, or portions thereof, can be implemented to run on any type of processing device including, but not limited to, a computer, workstation, embedded system, networked device, mobile device, or other type of processor or computer system capable of carrying out the functionality described herein.

As will be described in further detail below, memory 120 can be used to store information accessible by well schematic generator 110 for implementing the processes described herein. Memory 120 may be any type of recording medium coupled to an integrated circuit that controls access to the recording medium. The recording medium can be, for example and without limitation, a semiconductor memory, a hard disk, or other similar type of memory or storage device. Moreover, memory 120 may be integrated within system 100 or an external device communicatively coupled to system 100. In some implementations, memory 120 may be a remote cloud-based storage location communicatively coupled to system 100 over a network 104 via network interface 130. Network 104 can be any type of network or combination of networks used to communicate information between different computing devices. Network 104 can include, but is not limited to, a wired (e.g., Ethernet) or a wireless (e.g., Wi-Fi and 3G) network. In addition, network 104 can include, but is not limited to, a local area network, medium area network, and/or wide area network such as the Internet.

Source document 106 may be a printed document or an electronic document that contains information about one or more wells. For example, a well may typically include various equipment such as casing strings, pipes, drilling assemblies, production tubing, and other drilling or production tools. The wellbore itself may be characterized by various physical characteristics such as diameters, lengths, deviation angles, materials of construction such as cement, etc., as well as environmental characteristics, such as formation type, pressure, temperature, porosity, permeability, etc. Accordingly, source document 106 may contain information about the wellbore, the formation in which the wellbore is formed, and/or the various equipment in the wellbore, all of which may be characterized as components that comprise the well. For example, in a particular well, surface and intermediate casing may be cemented into the wellbore, and production casing may be placed into the wellbore. An upper portion of the wellbore may be drilled at a first wellbore diameter with casing of a first casing diameter installed and cemented therein. A lower portion of the wellbore may be drilled at a second wellbore diameter smaller than the first wellbore diameter, with casing of a second casing diameter installed and cemented therein. The wellbore is drilled to its total depth (vertical, directional, or horizontal), with consecutively decreasing diameters with increasing total depth.

Various components of a well may be tools or other equipment deployed in the well. A non-limiting example of such components includes production casing, packers, centralizers, slips, pumps, valves, crossover subs and gravel packs. Each of these components may have one or more physical and/or operational characteristics. Additionally, a component may be associated with a particular commercial product (e.g., a particular brand of packer).

In one or more embodiments, one or more source documents 106 are collected, the source document(s) 106 containing one or more features associated with an existing well. A feature may be a text string and/or an image region. A text string may describe, for example, a well schematic component such as the wellbore's length, depth, or diameter, a tool's name, model, brand, etc. An image region may include, for example, a symbol that represents a well schematic component, such as a packer or production casing, or an arrow associated with a text string/symbol. In some examples, source document 106 may be incomplete, may be of poor quality, or may contain erroneous information, inaccurate information, out-of-date information or ambiguous elements. For example, source document 106 may have been produced years earlier, by a different company using a manual process (e.g., drafting table or equivalent), and based on outdated methodologies or using obsolete equipment. For example, the nature of well schematics is that they are normally not drawn to scale. Vertical and horizontal scales may be different. Moreover, the vertical scale may be non-linear, and not logarithmic, as it may be based on the intensity and importance of the elements it has to represent along its path.

In any event, one or more source documents 106 are provided to well schematic generator 110 for processing. If source document 106 is a printed document, a scanner 108 can be used to digitize the printed source document and generate an electronic copy of the source document for processing by well schematic generator 110. In some examples, the source document 106 may be scanned into a Portable Document Format (PDF) and well schematic generator 110 may include a program (e.g., character text recognition) to read the PDF document. In some examples, well schematic generator 110 may include a program that performs character text recognition on source document 106 and provides a user with the number of times certain terms or words appear in source document 106. Well schematic generator 110 may also extract a list of words or terms from the document.

Well schematic generator 110 receives source document 106 as input and processes it in order to generate well schematic topology 132. Well schematic topology 132 is a schematic of a well and includes information about its components (e.g., materials of construction, dimensions, equipment deployed in the well, etc.), as well as information pertaining to the hierarchical and geometric relationships among the components. Context engine 112, coordinate map generator 114, and business rules engine 116 may process source document 106 and compare it to data stored in component database 122 and/or expertise database 124 to generate well schematic topology 132. These databases may store information about different types of wells and their components. Well schematic generator 110 may partition source document 106 into a coordinate map and extract features from the coordinate map that can be individually and collectively compared to data stored in component database 122 and/or expertise database 124.

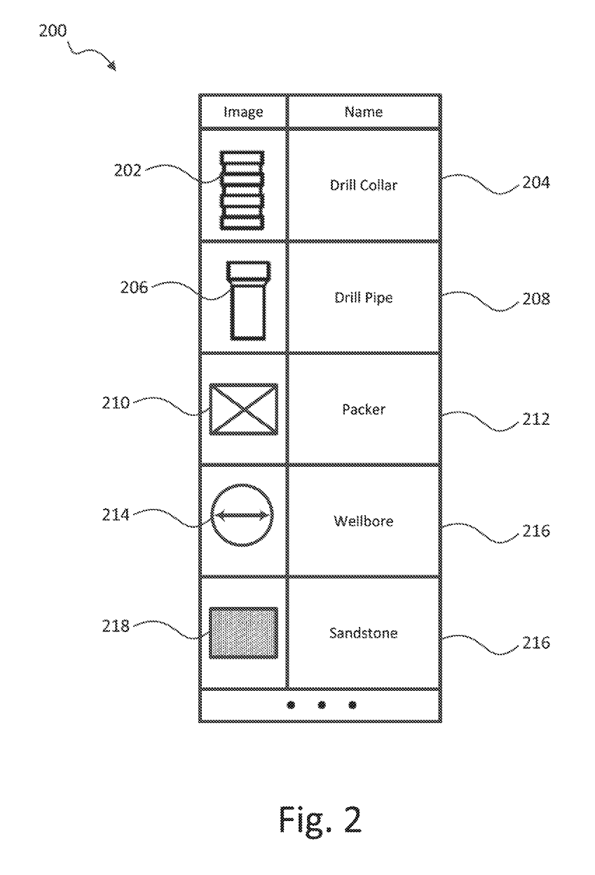

Component database 122 includes one or more catalogued images. A catalogued image may represent a well schematic component. FIG. 2 illustrates an example of data stored in component database 122 in accordance with one or more embodiments of the present disclosure. In FIG. 2, a data table 200 is stored in component database 122 and includes at least five catalogued images, and each of the images is mapped to its name. For example, an image 202 in a first row 204 of data table 200 represents a drill collar, an image 206 in a second row 208 of data table 200 represents a drill pipe, and an image 210 in a third row 212 of data table 200 represents a packer. The images need not be limited to equipment within the well, but may represent the wellbore itself, such as image 214 in a fourth row 216 where a cross-section of the wellbore is depicted. In addition, the images may represent the formation in which the wellbore is drilled, such as image 218 in a fifth row 220 where a particular type of formation is identified (e.g., sandstone). Moreover, it will be appreciated that in addition to equipment within the well, the images may include equipment at the wellhead or above the wellhead and deployed in association with the well.

Expertise database 124 may include one or more business or well design rules that may be applied to a well schematic topology. A business rule may be that the diameter of a well decreases as the depth of the well increases. If a well schematic topology is generated that violates this rule, business rules engine 116 may make a determination about the topology in order to resolve the violation. For example, a determination may be made that the well schematic topology is upside down (if the diameter of the well consistently increases as the depth increases and all other business rules are satisfied) or that an error has occurred (if a first diameter above a second diameter of a well is larger than the second diameter, but a third diameter below the second diameter of the well is also larger than the second diameter). Based on the determination, a correction can be implemented in the well schematic topology in order to ensure the well schematic topology that is generated complies with the business rules of database 124.

Additionally, expertise database 124 may store information associated with well schematic components and/or the catalogued images stored in component database 122. For example, expertise database 124 may store product data, brochures, material properties and other physical or operational parameters of components, as well as cost information, an inventory of how many components are in stock, etc. Additionally, well schematic generator 110 may be trained to recognize various combinations of well schematic components. For example, well schematic generator 110 may identify a plurality of well schematic components that when presented together make up a particular well schematic component. For example, the individual components of a screen assembly, a valve assembly and two packers may be identified as a completion component.

Existing techniques for automatically generating or digitizing drawings rely on a variety of technologies, including image recognition, expert systems that search documents for images or text, and software libraries that are used to populate a blank drawing canvas with shapes that represent printed well schematic components. The present disclosure combines these existing technologies with techniques for inferring the design of a well and its components (e.g., casing, tubing, and drill strings) from context-based graphical and textual information contained in the source documents, obviating the need to manually input that data into expertise database 124 or component database 122 in order to generate a complete design schematic of a well.

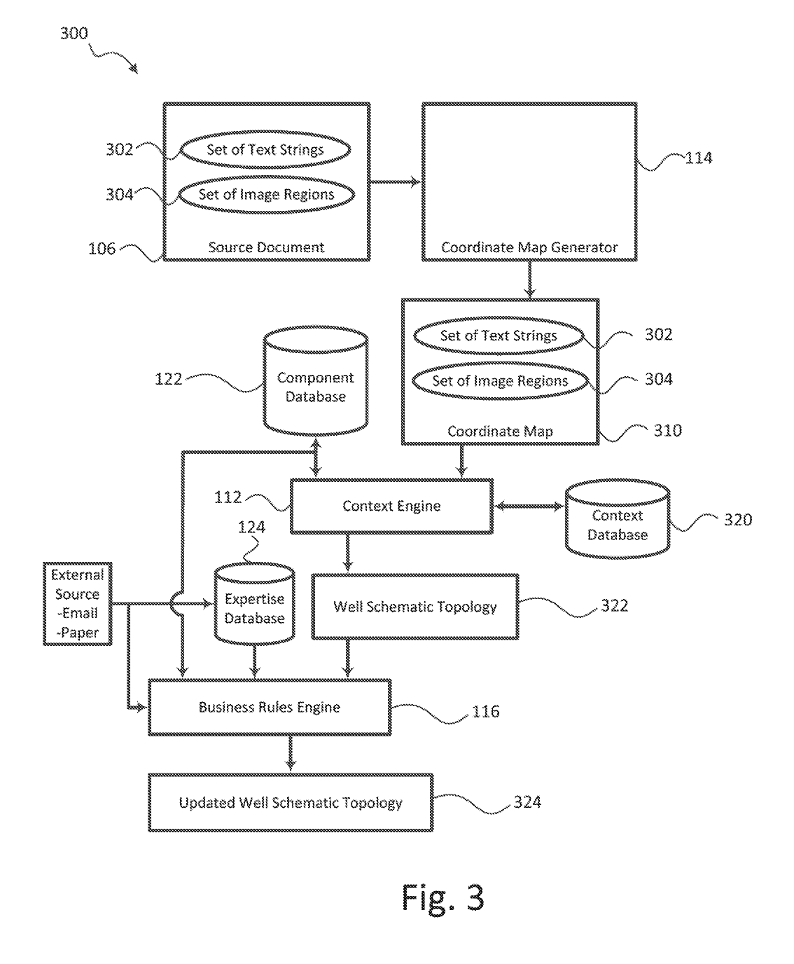

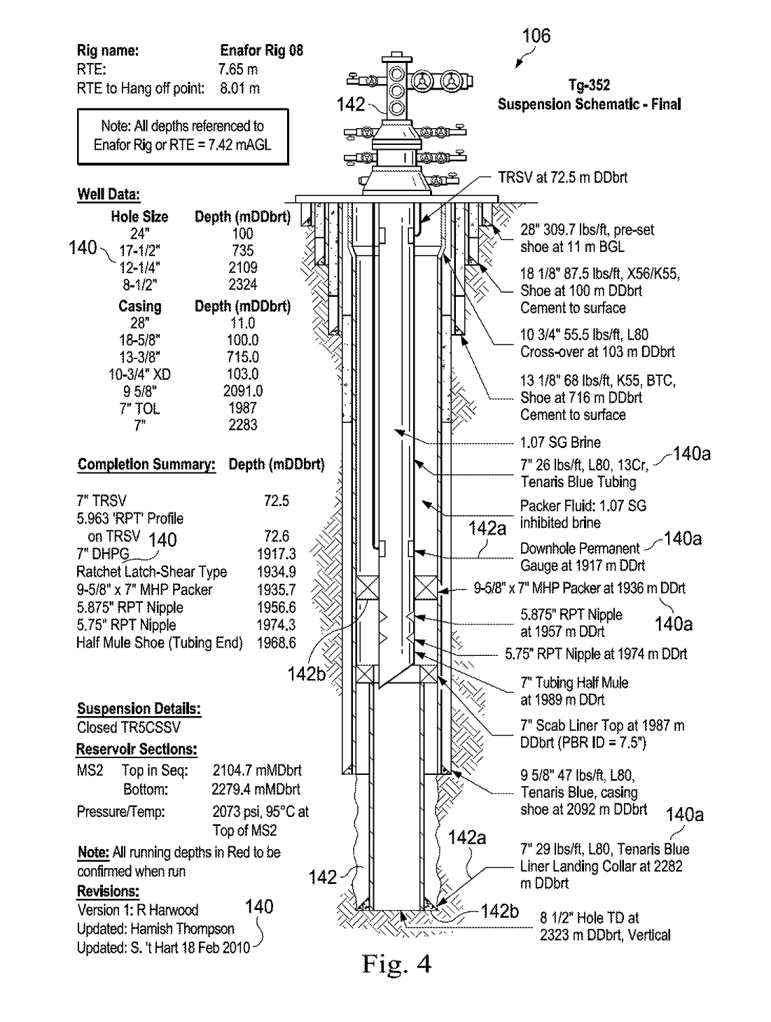

With reference to FIGS. 3, 4, and 5, FIG. 3 illustrates a process flow for generating a well schematic topology based on one or more source documents in accordance with one or more embodiments of the present disclosure. A source document 106, which is illustrated in FIG. 4, may include text 140, images 142, or both associated with a feature of the well. Each feature, in turn, is associated with a component of a well. The components of a well might be anything associated with the well, including the tools or equipment within a well (or even at the surface), attributes of the wellbore itself, such as diameter or length, or even attributes of the formation in which the wellbore is drilled, such as the type of rock around a formation at a particular depth, porosity or permeability. Additionally, features may be nested. In some examples, a feature may also include one or more other features. For example, a feature may be an image, which may also contain other features, such as text. In any event, in one or more embodiments, certain text 140a may be presented in proximity to an image 142. Additionally, certain images 142a may establish connectivity between such text 140a and another proximate image 142b. Although the connectivity image 142a may be any image, in one or more embodiments, connectivity image 142a may be an arrow or line extending from the vicinity of text string 140a to the vicinity of image 142b. The text 140 and images 142 present data and information about one or more well features to be presented as well schematic components.

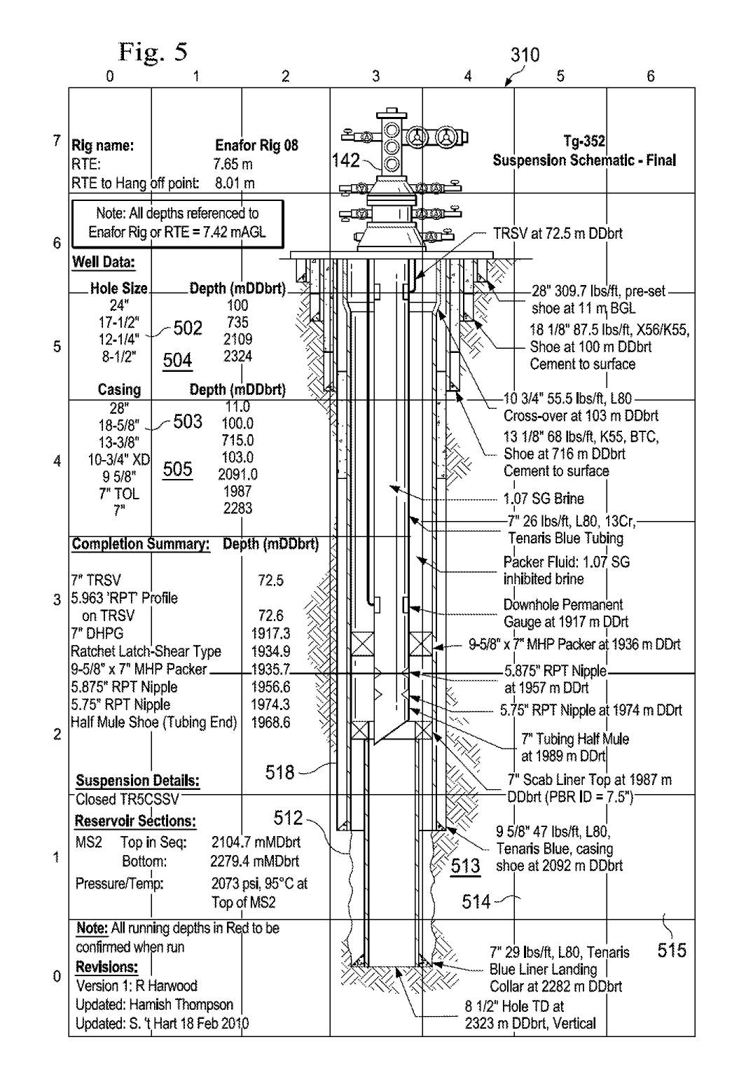

Referring back to FIG. 3, coordinate map generator 114 receives source document 106 and may partition it into cells to generate a coordinate map 310, which is illustrated in FIG. 5. In one or more embodiments, the partition may be a grid formed of a plurality of cells. The grid may be an X-Y grid or some other coordinate system. It will be appreciated that the level of gradation or size of the cells may be adjusted as necessary to refine the procedures described herein. In any event, within each cell, the coordinate map generator 114 identifies text 140 and images 142 within the source document 106 and extracts them as a set of text strings 302 and a set of image regions 304, which are stored in coordinate map 310. In other words, coordinate map generator 114 may generate coordinate map 310 including a set of text strings 302 and a set of image regions 304 derived from source document 106. As such, coordinate map generator 114 may define the image regions and text strings generated from the extracted data from source document 106. In some embodiments, coordinate map generator 114 uses a robot navigational technique to parse and reconstruct engineering drawings from low-quality printed sources. Coordinate map 310 may be used to aid in generating a well schematic topology of a well. In FIG. 5, coordinate map 310 illustrates an X-Y coordinate system having 42 cells and includes the features contained in source document 106 illustrated in FIG. 4. As shown in FIG. 5, cells 502-505 and 514 and 515 contain only text strings, while cells 512 and 518 contain only image regions. Cell 513 contains both an image region and a text string.

Context engine 112 may receive coordinate map 310 as an input and associate one or more text strings of set of text strings 302 with one or more image regions of set of image regions 304. An image region may include one or more image patterns. Context engine 112 may perform pattern matching techniques to each defined image region in order to identify features. In one or more embodiments, context engine 112 may include a program that is able to gauge a deeper context of text 140 in source document 106. Thus, in one or more embodiments, context engine 112 may include a semantics engine (not shown) that parses one or more sentences in source document 106 and understands its meaning. Likewise, in one or more embodiments, context engine 112 may include an image recognition engine that searches and identifies particular shapes in an image. Context engine 112 may identify individual segments of an image region corresponding to wellbore components for which additional information is desired (e.g., a piece of tubing, internal control valve, etc. in a well). It may be unnecessary for the contextual information (e.g., text labels, dimensions, depth markers, or component images) to be stored in a predetermined database format. Context engine 112 may compare the features in coordinate map 310 with the data in component database 122, which stores one or more catalogued images that represent well schematic components. For each image region, context engine 112 may search component database 122 using a combination of image pattern and associated text strings from coordinate map 310.

Context engine 112 may associate a first feature with a second feature in coordinate map 310. For example, context engine 112 may associate a text string of set of text strings 302 with an image region of set of image regions 304. The association between the text string and the image region may be based on a context of the text string in coordinate map 310. In one or more embodiments, context engine 112 determines a distance between one or more text strings and one or more image regions in coordinate map 310, where the context includes a distance between the text string and the image region in the coordinate map. Context engine 112 may utilize a connectivity image 142a to establish an association between a first feature, such as text 140a, and a second feature, such as image 142a. In other embodiments, context engine 112 may count the number of image regions and apply a clustering algorithm to associate one or more text strings with one or more image regions included in coordinate map 310. A first text string that is closer to an image region compared to a second text string may have a higher probability of being associated with the image region compared to the second text string, although this may not always be the case. For example, in some cases, even though the second text string is farther from the image region than the first text string, the second text string may be associated with an image region, as described above, using a connectivity image 142a or other means of association. As an example, context engine 112 may identify an arrow or line included in an image region and associated with a dimension of a well schematic component. Context engine 112 may determine the component to which the dimension corresponds and may associate the dimension (e.g., text string) with the image region including the component to which the dimension corresponds.

In FIG. 5, a lower portion of image region 502 includes a text string “Casing” and a lower portion of image region 504 includes a text string “Depth (mDDbrt).” Additionally, image region 503, which is adjacent image region 502, includes text strings “28″”, “18⅝″”, “13⅜″”, “10¾″X”, “9⅝″”, “7″ TOL”, and “7″”, and image region 505, which is adjacent image region 504, includes text strings “11.0”, “100.0”, “715.0”, “103.0”, “2091.0” “1937” and “2283”. Context engine 112 may recognize that the text strings “28″”, “18⅝″”, “13⅜″”, “10¾″ XO”, “9⅝″”, “7″ TOL”, and “7″” are below, but proximate to text string “Casing” and that the text strings “11.0”, “100.0”, “716.0”, “103.0”, “2091.0” “1987” and “2283” are below, but proximate to text string “Depth” so as to be connected, respectively. In this regard, context engine 112 may recognize that in addition to being proximate one another, the respective text is arranged in a particular manner. For example, “casing” column aligns with the “Depth” column and that the text strings in image region 503 and 505 contain equal length lists. Context engine 112 may determine that these text strings correspond to each other and identify with which particular feature(s) (e.g., casing) the text strings in the “Depth” column are associated. For example, context engine 112 may determine, based on the context of these text strings in coordinate map 310, that the first text string below “Casing” corresponds to the first text string below “Depth” (e.g., the 28″ casing string is located at a depth of 11.0 mDDbrt), the second text string below “Casing” corresponds to the second text string below “Depth” (e.g., the 118⅝″ casing string is located at a depth of 100.0 mDDbrt), and so on.

Context engine 112 may maintain context information in a context database 320. Context database 320 may include associations and relationships between features in one or more external coordinate maps, as well as associations and relationships between features in coordinate map 310. Context database 320 may be used to determine context as described above based on comparison with associations and relationships derived from external coordinate maps. Moreover, context engine 112 may identify features in coordinate map 310 and store them as (key, value) pairs. For example, context engine 112 may map each string in image region 503 to an adjacent string in image region 505.

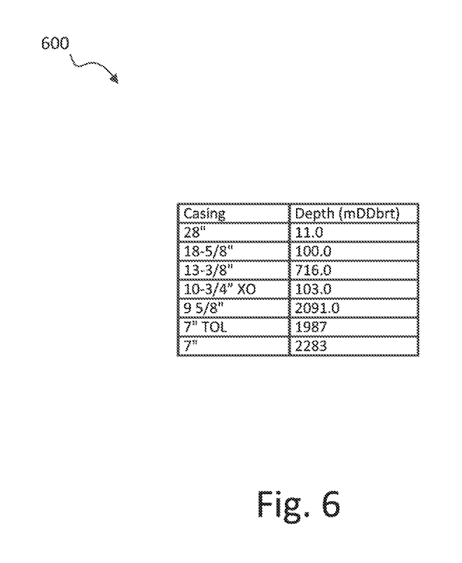

FIG. 6 illustrates an example of a two-column data table 600 that is produced by context engine 112 in accordance with one or more embodiments of the present disclosure by establishing context between each of cells 502, 503, 504 and 505 from FIG. 5. Data table 600 may be stored in context database 320 and indicates that a 28″ casing string is at a depth of 11.0 mDDbrt, a 18⅝″ casing string is at a depth of 100.0 mDDbrt, and so on. The particular casing strings may be in a wellbore at those indicated depths. In the illustrated embodiment of FIG. 6, context engine 112 establishes that the text casing appearing in the lower portion of cell 502 is in proximity to the text “28′” in the upper portion of adjacent cell 503. Moreover, context engine 112 established that all of the text in cell 503 is aligned in a column to suggest that “casing” as shown in cell 502 is associated with the column. Additionally, context engine 112 likewise established the foregoing for the “Depth” column. Finally, context engine 112 establishes a relationship between the two columns. Specifically, the text in the lower portion of cell 502 is positioned in the same location as the text in the lower portion of adjacent cell 504, and the text in cell 503 is positioned in the same relative position as the text in adjacent cell 505, thereby indicating that the column in cells 502 and 503 are related to the column in cells 504 and 505. In some examples, context engine 112 extracts a unit of measurement (UOM) from coordinate map 310 or data table 600 and converts the UOM into another form. For example, context engine 112 may extract the UOM “inches” from data table 600 or coordinate map 310, convert the fractional values into decimal values, and compute the length of each known casing string listed in data table 600. Likewise, units of measurement may be converted between systems of measurement, such as feet to meters.

Referring back to FIG. 5, context engine 112 may recognize that a feature in image region 512 is associated with one or more text strings in image regions 513-515. Context engine 112 may parse the text in image regions 513-515, extract the depth “2092 mDDbrt,” and map these features to known key-value pair <“Casing: 9⅝”, 2091.0> from the previous region mapping (see data table 600). Context engine 112 may insert this association information into context database 320. Accordingly, a result may be a topological marker of the end of the casing string that may be used to place other well features in their correct positions relative to that casing string. Although the depth “2091.0” as indicated in the text string in cell 505 may be inconsistent with the depth “2092 mDDbrt” as indicated in the text string in cell 514, context engine 112 may have the intelligence to associate the “2091.0” text string in cell 505 with the “2092 mDDbrt” text string in cell 514 because the “2092 mDDbrt” text string in cell 514 is in close proximity to the text string “9⅝” in cell 513. The text string “9⅝” in cell 513 may correspond with the text string “9⅝” in cell 503.

It should be understood that these are merely examples of associations and contextual information that may be identified by context engine 112, and context engine 112 may store additional information associated with coordinate map 310 or other coordinate maps into context database 320. Additionally, it should be understood that although source document 106 is illustrated as being partitioned using an X-Y grid, this is not intended to be limiting. Additionally, one or more of the image regions in source document 106 may be of different sizes.

In some embodiments, context engine 112 links one or more image regions of set of image regions 304 with a corresponding catalogued image stored in component database 122. For example, image region 518 includes image 210 (see FIG. 2), which represents a packer. Accordingly, context engine 112 may identify image region 518 (which contains image 210) and link image region 518 with corresponding catalogued image 210 stored in component database 122. Context engine 112 may link one or more image regions of set of image regions 304 with a corresponding catalogued image stored in component database 122 by comparing one or more image regions with catalogued images stored in component database 122. Context engine 112 may determine, based on the one or more comparisons, whether an image region and a catalogued image stored in component database 122 satisfy a correlation threshold. An image region and a catalogued image may satisfy the correlation threshold if their similarities to each other are above the correlation threshold. For example, context engine 112 may detect an image of an object having more rings than the number of rings illustrated in image 202 of FIG. 2. Although the object has more rings than the number of rings illustrated in image 202, context engine 112 may compare the image region including the object with catalogued image 202 and determine that they satisfy the correlation threshold. The library of images stored in component database 122 may evolve over time. In some examples, a drill collar may have multiple images in component database 122 associated with the drill collar. In some examples, the correlation threshold and identification rules may be modified as new exceptions arise.

Context engine 112 may link an image region with a catalogued image in response to a determination that the image region and the catalogued image satisfy the correlation threshold. In some examples, context engine 112 applies a regression analysis to determine whether the image region and catalogued image satisfy the correlation threshold. In an example, context engine 112 may determine whether the image region includes the catalogued image. In this example, if the image region includes the catalogued image, the image region and catalogued image satisfy the correlation threshold. In another example, if an image region includes an image that has similar features to that included in a catalogued image, the image region and the catalogued image satisfy the correlation threshold.

In some examples, a user may identify an image region in coordinate map 310 and recognize one or more well schematic components in the image region. For example, the user may identify an interval control valve in an image region and determine that it is of a brand “ABC” by looking at the text associated with the interval control valve in coordinate map 310. The user may instruct context engine 112 to add the image region with metadata (e.g., brand “ABC”) corresponding to the associated text string (e.g., interval control value) to component database 122, create a label for the new image region, and mark it as satisfying the correlation threshold. Context engine 112 may determine that the image region and catalogued image satisfy the correlation threshold and store a component identifier (ID) of the well schematic component into coordinate map 310 at the image region location. The well schematic component may be assigned a component ID that is used to place it properly in well schematic topology 322. A component ID is unique to the well and is used to form the parent-child relationship in well schematic topology 322 and indicates a set of instructions on how to build the well. For example, a first component assigned a first component ID may be at a lower depth in well schematic topology 322 than a second component assigned a second component ID because the first component ID is less than the second component ID.

One or more regions of set of image regions 304 may be made successively smaller or larger in order to capture features of different sizes. In some examples, an image region may be further partitioned into smaller image regions. For example, if none of the features in an image region matches data (e.g., an image) stored in component database 122, context engine 112 may further partition the image region into smaller image regions until the image region reaches a size threshold and/or until context engine 112 identifies features within the image region that match data in component database 122. In some examples, context engine 112 may identify features included in an image region and further zoom into the image region to identify additional features. For example, context engine 112 may further partition an image region of a coordinate map 310 into smaller image regions to recognize text strings located near identified features. For example, context engine 112 may zoom in and identify a pump in a coordinate map and may further zoom into the pump to identify a brand of the pump.

Context engine 112 may generate well schematic topology 322 in accordance with coordinate map 310 and the one or more catalogued images linked with one or more image regions. Well schematic topology 322 may be based on data stored in component database 122 and coordinate map 310. Well schematic topology 322 may be an image of a wellbore, its components, and/or information about the components (e.g., depth, material, etc.).

Referring back to FIG. 3, business rules engine 116 may use well schematic topology 322 as an input and update it in accordance with one or more business rules. Business rules engine 116 may search expertise database 124 for one or more business rules to apply to well schematic topology 322. Expertise database 124 may include information about wells. For example, expertise database 124 may store information about the proper maintenance of particular types of wells. Expertise database 124 may be a virtual database that stores information from heterogeneous sources (e.g., email applications, word applications, drawing applications, etc.).

In some examples, expertise database 124 stores the information into data tables based on different data models. For example, extensible markup language (XML) may be used to describe data and create a “well” data type. Each well has at least one wellbore, which itself has at least one casing string and at least one cemented region. This information may be used to create a “well” data type that includes a field for the casing string and cemented region, and this information may be mapped to expertise database 124. Business rules engine 116 may fill in the fields based on information from expertise database 124 and well schematic topology 322. Additional information may be added to expertise database 124 to update the “well” data type and create other data types. The information in expertise database 124 may be updated in order to train the system to provide the most up-to-date recommendations and information about wells. For example, contextually available pieces of information based on image recognition or the most up-to-date well building practices may be stored in expertise database 124.

In some examples, business rules engine 116 may process well schematic topology 322 and perform a strength assessment of the well described in well schematic topology 322. For example, business rules engine 116 may provide a live interaction description of the well that draws upon actual material and product specifications that are known for the types of equipment of which the well is composed. For example, business rules engine 116 may identify the year in which the well was built and search expertise database 124 for information specific to wells built in that particular year. Business rules engine 116 may then apply the appropriate business rules for the well. In some examples, expertise database 124 stores a library of well types and the wellbore components that make up each well type. In an example, coordinate map 210 includes the text string “Year 1990” and context engine 112 determines based on this text string and other information in coordinate map 310 that the well was built in 1990. Context engine 112 may pass this information along to business rules engine 116. Based on one or more business rules stored in expertise database 124 and the thickness of a production casing specified in well schematic topology 322, business rules engine 116 may determine that the casing in the well is made of a particular type of steel, that corrosion of the steel has probably progressed to a certain point, and provide a recommendation about the integrity of the well to the user. Business rules engine 116 may provide the user with the particular steel properties and design considerations and maintenance procedures that should be taken into account given the steel's properties.

Business rules engine 116 may sort set of image regions 204 into an order that is based on a design sequence for building a well and update well schematic topology 322 based on the sorted set of image regions. In some examples, expertise database 124 stores a library of the best design practices for building a well. If a part of source document 106 is missing or obscured, well schematic topology 322 may also be missing well schematic components or other important information. Business rules engine 116 may be able to identify the missing components by knowing that the particular well being described by well schematic topology 322 typically has a first component at a first depth, a second component at a second depth, and so on. Accordingly, even if source document 106 does not contain the first or second component, business rules engine 116 may include the missing component(s) in updated well schematic topology 324 based on the best practices specified in expertise database 124. In an example, business rules engine 116 determines whether a subset of image regions includes a first set of design components that satisfies a design threshold. In response to a determination that the first set of design components does not satisfy the design threshold, business rules engine 116 may determine a second set of design components missing from the subset of image regions and update well schematic topology 322 by adding the second set of design components to the well schematic topology. In this example, updated well schematic topology 324 includes the second set of design components. A representation of the second set of design components may be stored in component database 122 or expertise database 124, and business rules engine 116 may add the missing well schematic component(s) to well schematic topology 322 to generate updated well schematic topology 324.

In some examples, business rules engine 116 may determine that a well schematic typically has the conductor casing at the top of the well, the intermediate casing at the middle of the well, the production casing at the bottom of the well, and production tubing along a vertical plane of the well. Business rules engine 116 may create and/or confirm the dimensions of the well and update well schematic topology 322 by placing the individual well schematic components in well schematic topology 224 in the proper locations based on the knowledge of how particular components are typically put together to make it a consistent system. For example, if well schematic topology 322 is upside down and provided as input into business rules engine 116 as such, business rules engine 116 may recognize that well schematic topology 322 is upside down and would not build the well schematic topology upside down. For example, business rules engine 116 may recognize that a well cannot start out with a small production bore and large diameter conductor hole at the bottom of the well. Rather, business rules engine 116 may re-organize the components illustrated in well schematic topology 322 such that the components are in their proper locations.

Additionally, business rules engine 116 may recognize that if a packer is deployed in a wellbore, there is a high probability that an outer casing is deployed in and disposed around an inner tubular of the well to fill the annulus. Accordingly, if business rules engine 116 identifies a packer in well schematic topology 322, business rules engine 116 may also look for information about the outer casing.

In some examples, business rules engine 116 may parse the data in well schematic topology 322 and determine whether additional information should be included in well schematic topology 322. Business rules engine 116 may identify parts of the well described in well schematic topology 322 and place it into context through additional analysis using expertise database 124. Accordingly, business rules engine 116 may provide the user with a deeper understanding of the well described in well schematic topology 322 by updating it with more information. For example, well schematic topology 322 may include a representation of a pump and business rules engine 116 may find information about the pump in expertise database 124 to provide the user with additional information about the pump. In this example, business rules engine 116 may inform the user when the pump was last serviced, the cost of installing the pump, the brand of the pump, the model number of the pump, etc. Business rules engine 116 may determine that the company bought 10 of these pumps in year 2012 and that the pump listed in well schematic topology 322 was serviced 5 years ago and has 6 months of useful life. Based on this information, the user may submit a service request for inspection of the well and note that this particular pump has an additional 6 months of useful life left. Accordingly, rather than the user attempting to locate information about this particular pump by sifting through hard files in the company, business rules engine 116 may bring up its associated information and provide a context of the well and in particular this pump to the user.

Business rules engine 116 provides more detailed information about individual well schematic components (reports, product data, etc.) to the user. The user may interact (hover, click, etc.) with well schematic components on a viewing device, such as a computer screen, and the schematic component can be associated with product catalog data (using context-based text information or image recognition). In some examples, business rules engine 116 links a well schematic component in well schematic topology 322 to product data about the well schematic component and updates well schematic topology 322 by providing a reference to the product data in updated well schematic topology 324. In some examples, business rules engine 116 links a well schematic component in well schematic topology 322 to product data about the well schematic component and updates well schematic topology 322 by providing the product data in updated well schematic topology 324.

In an example, business rules engine 116 may recognize that a packer included in image region 518 is of brand “ABC.” Accordingly, business rules engine 116 may point a browser (not shown) to ABC's website. Business rules engine 116 may determine the packer's brand based on image recognition or the text string “ABC” near the packer. The browser may execute on the computing device on which well schematic generator 110 is executing. From the website, business rules engine 116 may be able to determine the packer's true dimensions, its cost, its material composition, the materials with which the packer is compatible, useful life, etc. This information may be provided to the user via a display. Accordingly, the user may become aware if the packer is approaching the end of its useful life and should be replaced. If the user determines that the packer should be replaced soon, the user may order the packer from ABC and schedule a work order for this well. If the user were not aware that the packer was approaching the end of its useful life, the well may end up with a leak or a failure that may be expensive and time consuming to fix.

As discussed above and further emphasized here, FIGS. 1-6 are merely examples, which should not unduly limit the scope of the claims. For example, although coordinate map generator 114 is described as generating a coordinate map based on a source document including a set of text strings and a set of image regions, it should be understood that coordinate map generator 114 may generate a coordinate map based on a source document including only a set of text strings or generate a coordinate map based on a source document including only a set of image regions.

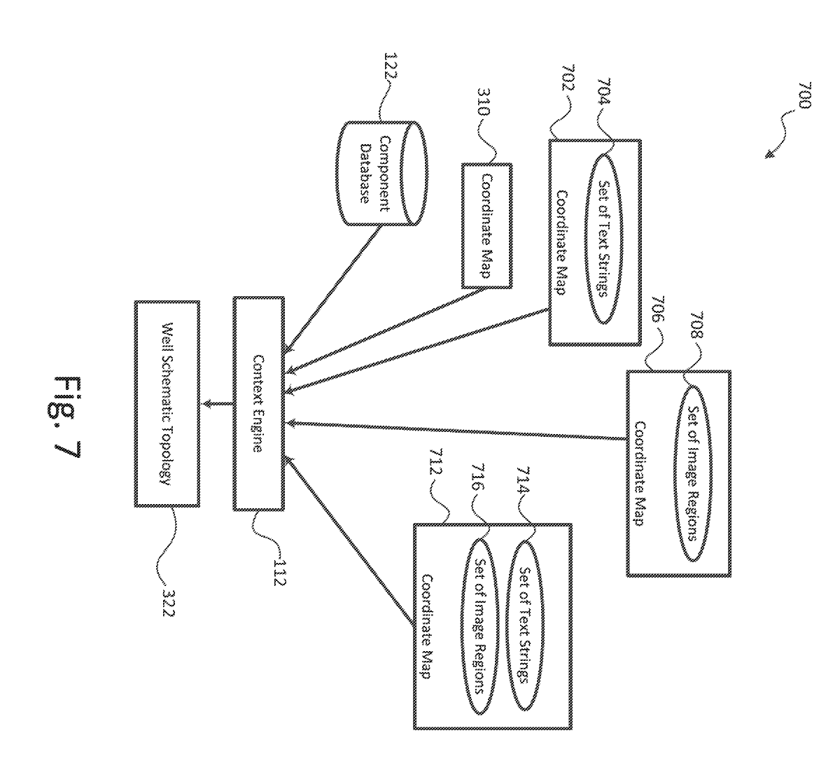

Additionally, although well schematic topology 322 is described as being based on one coordinate map (e.g., coordinate map 310) and one or more catalogued images linked with one or more image regions included in the coordinate map, this is not intended to be limiting and it should be understood that well schematic topology 322 may be based on a plurality of coordinate maps. For example, context engine 112 may store associations between text strings and image regions from multiple coordinate maps in component database 122 and then generate well schematic topology 322 based on information from different coordinate maps. FIG. 7 illustrates a block diagram 700 of context engine 112 collecting information from multiple coordinate maps and generating well schematic topology 322 based on a plurality of coordinate maps and data stored in component database 122. In FIG. 7, coordinate map 702 stores a set of text strings 704. Coordinate map generator 114 may store set of text strings 704 into coordinate map 702. In some examples, context engine 112 associates one or more text strings of set of text strings 704 with one or more image regions of set of image regions 304. A text string of set of text strings 704 may be associated with an image region of set of image regions 304 based on a context of the text string in coordinate map 702 and/or based on a context of the image region in coordinate map 310. Context engine 112 may link one or more image regions of set of image regions 304 with a corresponding catalogued image stored in component database 122. Context engine 112 may further generate well schematic topology 322 in accordance with the one or more catalogued images linked with the one or more image regions of set of image regions 304, coordinate map 310, and/or coordinate map 702.

Additionally, coordinate map 706 stores a set of image regions 708. Coordinate map generator 114 may store set of image regions 708 into coordinate map 706. In some examples, context engine 112 associates one or more text strings of set of text strings 302 with one or more image regions of set of image regions 708. A text string of set of text strings 302 may be associated with an image region of set of image regions 708 based on a context of the text string in coordinate map 310 and/or based on a context of the image region in coordinate map 706. Context engine 112 may link one or more image regions of the set of image regions 708 with a corresponding catalogued image stored in component database 122. Context engine 112 may further generate well schematic topology 322 in accordance with the one or more catalogued images linked with the one or more image regions of set of image regions 708, coordinate map 310, and/or coordinate map 706.

Additionally, coordinate map 712 stores a set of text strings 714 and a set of image regions 716. Coordinate map generator 114 may store set of text strings 714 and set of image regions 716 into coordinate map 712. In some examples, context engine 112 associates one or more text strings of set of text strings 714 with one or more image regions of set of image regions 304. A text string of set of text strings 714 may be associated with an image region of set of image regions 304 based on a context of the text string in coordinate map 712 and/or based on a context of the image region in coordinate map 310. In some examples, context engine 112 associates one or more image regions of set of image regions 716 with one or more text strings of set of text strings 302. A text string of set of text strings 302 may be associated with an image region of set of image regions 716 based on a context of the text string in coordinate map 310 and/or based on a context of the image region in coordinate map 712. Context engine 112 may link one or more image regions of set of image regions 716 with a corresponding catalogued image stored in component database 122. Context engine 112 may generate well schematic topology 322 in accordance with the one or more catalogued images linked with the one or more image regions of image regions 716, coordinate map 310, and/or coordinate map 712. In some examples, context engine 112 may generate well schematic topology 322 based on data stored in component database 122, coordinate map 310, coordinate map 702, coordinate map 706, and/or coordinate map 712.

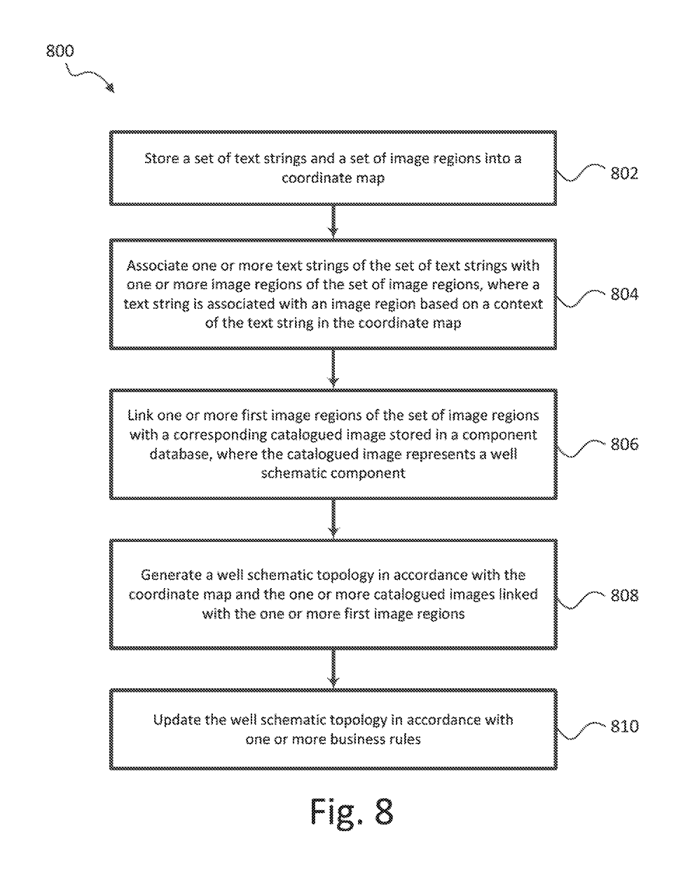

FIG. 8 is a process flowchart of an exemplary method 800 of providing a digital representation of a well schematic in accordance with one or more embodiments. Method 800 is not meant to be limiting and may be used in other applications. As shown in FIG. 8, method 800 includes steps 802, 804, 806, 808, and 810. For discussion purposes, method 800 will be described using computer system 100 of FIG. 1, as described above. However, method 800 is not intended to be limited thereto.

Method 800 includes a step 802, which includes storing a set of text strings and a set of image regions into a coordinate map. In an example, coordinate map generator 114 stores set of text strings 302 and set of image regions 304 into coordinate map 310. In a step 804, one or more text strings of the set of text strings is associated with one or more image regions of the set of image regions, where a text string is associated with an image region based on a context of the text string in the coordinate map. In an example, context engine 112 associates one or more text strings of set of text strings 302 with one or more image regions of set of image regions 304, where a text string is associated with an image region based on a context of the text string in coordinate map 310.

In a step 806, one or more first image regions of the set of image regions is linked with a corresponding catalogued image stored in a component database, where the catalogued image represents a well schematic component. In an example, context engine 112 links one or more first image regions of set of image regions 304 with a corresponding catalogued image stored in component database 122, where the catalogued image represents a well schematic component (e.g., casing string, packer, etc.).

In a step 808, a well schematic topology is generated in accordance with the coordinate map and the one or more catalogued images linked with the one or more first image regions. In an example, context engine 112 generates well schematic topology 322 in accordance with coordinate map 310 and the one or more catalogued images linked with the one or more image regions of set of image regions 304. In a step 810, the well schematic topology is updated in accordance with one or more business rules. In an example, business rules engine 116 updates well schematic topology 322 in accordance with one or more business rules stored in expertise database 124.

It is understood that additional processes may be inserted before, during, or after steps 802, 804, 806, 808, and 810 discussed above. It is also understood that one or more of the steps of method 800 described herein may be omitted, combined, or performed in a different sequence as desired.

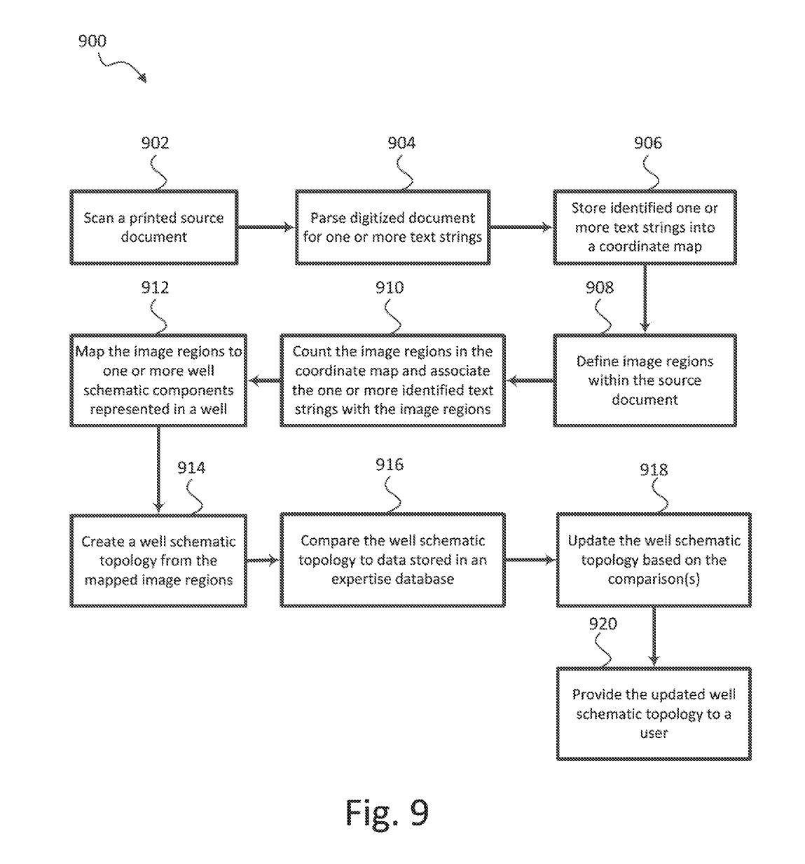

FIG. 9 is a process flowchart of an exemplary method 900 of providing a digital representation of a well schematic in accordance with one or more embodiments. Method 900 is not meant to be limiting and may be used in other applications. As shown in FIG. 9, method 900 includes steps 902, 904, 906, 908, 910, 912, 914, 916, 918, and 920. For discussion purposes, method 900 will be described using computer system 100 of FIG. 1, as described above. However, method 900 is not intended to be limited thereto.

Method 900 includes a step 902, which includes scanning a printed source document. In an example, the user scans in source document 106 using scanner 108. In a step 904, the digitized document is parsed for one or more text strings. In an example, coordinate map generator 114 parses the digitized source document for one or more text strings. In a step 906, one or more text strings is identified and stored into a coordinate map. In an example, coordinate map generator 114 stores one or more identified text strings into coordinate map 310.

In a step 908, image regions are defined within the source document. In an example, coordinate map generator 114 defines the image regions within source document 106. In some examples, coordinate map 310 is the source document partitioned by a grid. In a step 910, the image regions in the coordinate map are counted and associated with the one or more identified text strings. In an example, context engine 112 counts the image regions in coordinate map 310 and associates the one or more identified text strings with the image regions. In a step 912, the image regions are mapped to one or more well schematic components represented in a well. In an example, context engine 112 maps the image regions to one or more well schematic components represented in a well.

In a step 914, a well schematic topology is created from the mapped image regions. In an example, context engine 112 creates well schematic topology 322 from the mapped image regions. For example, context engine 112 may create well schematic topology 322 from the image regions mapped to catalogued images in component database 122 and stored in context database 320. In a step 916, the well schematic topology is compared to data stored in an expertise database. In an example, business rules engine 116 compares well schematic topology 322 to data stored in expertise database 124. In some examples, business rules engine 116 compares well schematic topology 322 to data stored in expertise database 124 by applying a regression algorithm to identify image regions and catalogued images that satisfy the correlation threshold. In some examples, business rules engine 116 adds well schematic components from component database 122 to fill in gaps between well schematic topology 322 and in accordance with a particular design sequence for building a well.

In a step 918, the well schematic topology is updated based on the comparison(s). In an example, business rules engine 116 updates well schematic topology 322 based on the comparison(s). In a step 920, the updated well schematic topology is provided to a user. In an example, business rules engine 116 provides well schematic topology 224 to a user, where well schematic topology 224 is an updated version of well schematic topology 322.

It is understood that additional processes may be inserted before, during, or after steps 902, 904, 906, 908, 910, 912, 914, 916, 918, and 920 discussed above. It is also understood that one or more of the steps of method 900 described herein may be omitted, combined, or performed in a different sequence as desired.

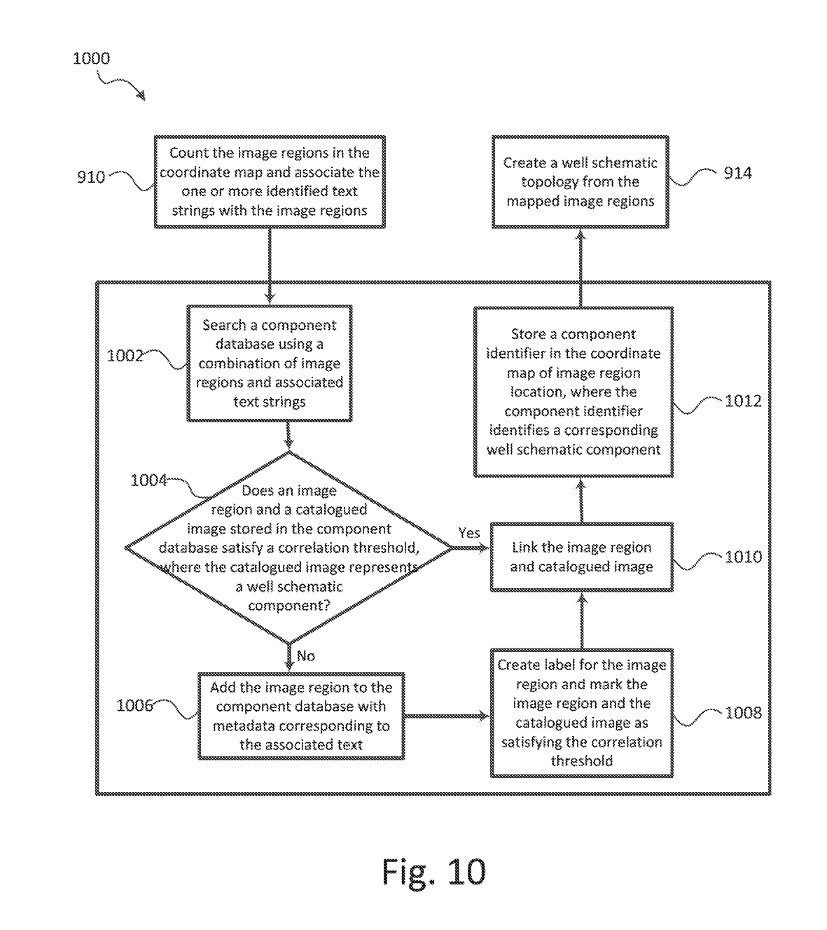

For example, FIG. 10 is a process flowchart of an exemplary method 1000 of storing a component identifier (ID) in a coordinate map in accordance with one or more embodiments. Method 1000 is not meant to be limiting and may be used in other applications. As shown in FIG. 10, method 1000 includes steps 910, 1002, 1004, 1006, 1008, 1010, 1012, and 914. For discussion purposes, method 1000 will be described using computer system 100 of FIG. 1, as described above. However, method 1000 is not intended to be limited thereto.

In method 1000, process flow proceeds from step 910 to a step 1002, which includes searching a component database using a combination of image regions and associated text strings. In an example, context engine 112 searches component database 122 using a combination of image regions of set of image regions 204 and associated text strings. In a step 1004, it is determined whether an image region and a catalogued image stored in the component database satisfy a correlation threshold, where the catalogued image represents a well schematic component. In an example, context engine 112 determines whether an image region of set of image regions 204 and a catalogued image stored in component database 122 satisfy a correlation threshold, where the catalogued image represents a well schematic component.

In response to a determination that an image region and a catalogued image stored in the component database do not satisfy the correlation threshold, process flow proceeds from step 1004 to a step 1006, in which the image region is added to the component database with metadata corresponding to the associated text. In an example, in response to a determination that an image region and a catalogued image stored in component database 122 do not satisfy the correlation threshold, context engine 112 adds the image region to component database 122 with metadata corresponding to the associated text. In a step 1008, a label for the image region is created and the image region and the catalogued image are marked as satisfying the correlation threshold. In an example, context engine 112 creates a label for the image region and marks the image region and the catalogued image as satisfying the correlation threshold. In this example, context engine 112 may store the label in context database 320. Process flow may proceed from step 1008 to a step 1010.

In response to a determination that an image region and a catalogued image stored in the component database satisfy the correlation threshold, process flow proceeds from step 1004 to step 1010, in which the image region and the catalogued image are linked. In an example, in response to a determination that an image region and a catalogued image stored in component database 122 satisfy the correlation threshold, context engine 112 links the image region and the catalogued image. In a step 1012, a component ID is stored in the coordinate map of the image region location, where the component ID identifies a corresponding well schematic component. In an example, context engine 112 stores a component ID in coordinate map 310 of the image region location, where the component ID identifies a corresponding well schematic component. Process flow proceeds from step 1012 to step 914, in which a well schematic topology is created from the mapped image regions.

It is understood that additional processes may be inserted before, during, or after steps 910, 1002, 1004, 1006, 1008, 1010, 1012, and 914 discussed above. It is also understood that one or more of the steps of method 1000 described herein may be omitted, combined, or performed in a different sequence as desired. In some embodiments, one or more of steps 1002, 1004, 1006, 1008, 1010, and/or 1012 may be performed for any number of image regions in a coordinate map.

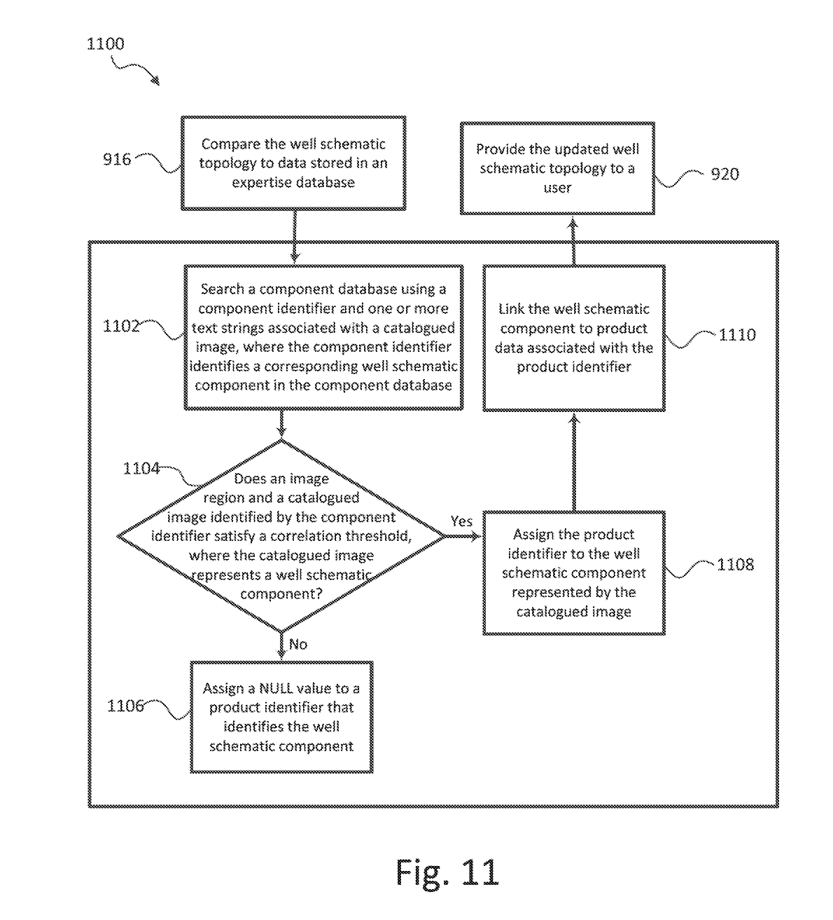

FIG. 11 is a process flowchart of an exemplary method 1100 of linking a well schematic component to associated product data in accordance with one or more embodiments. Method 1100 is not meant to be limiting and may be used in other applications. As shown in FIG. 11, method 1100 includes steps 916, 1102, 1104, 1106, 1108, 1110, and 920. For discussion purposes, method 1100 will be described using computer system 100 of FIG. 1, as described above. However, method 1100 is not intended to be limited thereto.

In method 1100, process flow proceeds from step 916 to a step 1102, in which a component database is searched using a component ID and one or more text strings associated with a catalogued image, where the component ID identifies a corresponding well schematic component in the component database. In an example, business rules engine 116 searches component database 122 using a component ID and one or more text strings associated with a catalogued image, where the component ID identifies a corresponding well schematic component in component database 122. In a step 1104, it is determined whether an image region and a catalogued image identified by the component ID satisfy a correlation threshold, where the catalogued image represents a well schematic component. In an example, context engine 112 determines whether an image region of set of image regions 204 and a catalogued image identified by the component ID satisfy a correlation threshold, where the catalogued image represents a well schematic component.

In response to a determination that an image region and a catalogued image identified by the component ID do not satisfy the correlation threshold, process flow proceeds from step 1104 to a step 1106, in which a product identifier that identifies the well schematic component is assigned a NULL value. In an example, in response to a determination that an image region and a catalogued image identified by the component ID do not satisfy the correlation threshold, business rules engine 116 assigns a NULL value to a product identifier that identifies the well schematic component. If a NULL value is newly assigned to a product identifier that identifies the well schematic component, it may be desirable to provide a subject matter expert with a visual inspection of the well schematic component. For example, a message may be sent to the subject matter expert, where the message includes the image region or an image of the particular well schematic component and a request for the subject matter expert to classify the component. Rules (e.g., in component database 122 or context database 320 or expertise database 124) may be amended based on the subject matter expert's input so that the system may properly identify the component if the image included in the image region is encountered again.

In response to a determination that an image region and a catalogued image identified by the component ID satisfy the correlation threshold, process flow proceeds from step 1104 to a step 1108, in which the product identifier is assigned to the well schematic component represented by the catalogued image. In an example, in response to a determination that an image region and a catalogued image identified by the component ID satisfy the correlation threshold, business rules engine 116 assigns the product identifier to the well schematic component represented by the catalogued image. In a step 1110, the well schematic component is linked to product data associated with the product identifier. In an example, business rules engine 116 links the well schematic component to product data associated with the product identifier. Process flow proceeds from step 1110 to step 920, in which the updated well schematic topology is provided to the user.

It is understood that additional processes may be inserted before, during, or after steps 916, 1102, 1104, 1106, 1108, 1110, and 920 discussed above. It is also understood that one or more of the steps of method 1100 described herein may be omitted, combined, or performed in a different sequence as desired. In some embodiments, one or more of steps 1102, 1104, 1106, 1108, and/or 1110 may be performed for any number of image regions in a coordinate map.

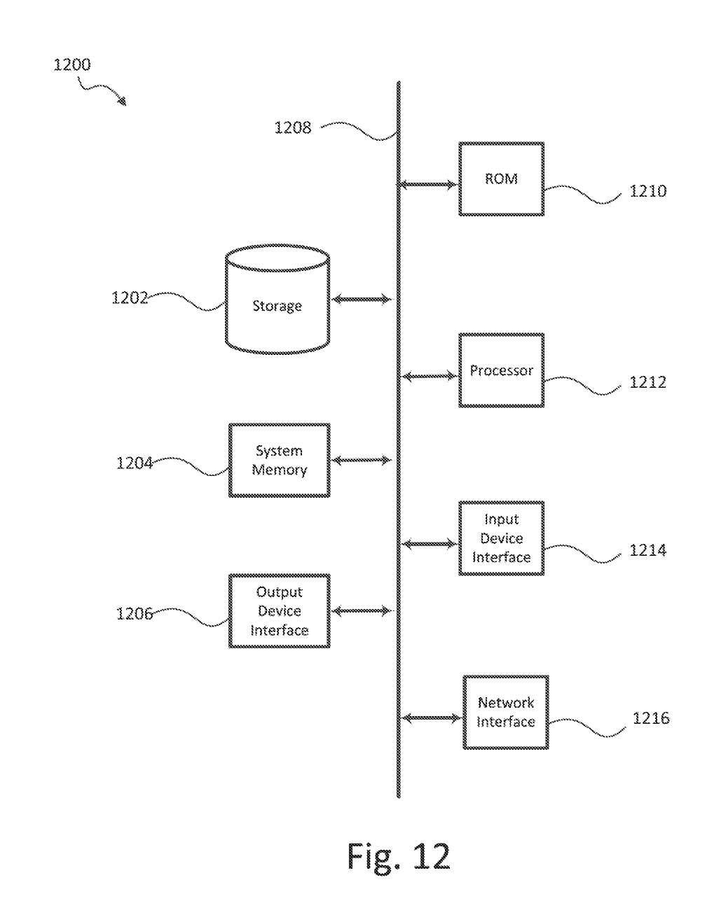

FIG. 12 is a block diagram of an exemplary computer system 1200 in which embodiments may be implemented. System 1200 can be a workstation, a laptop computer, a tablet computer, a server computer, a smartphone, and/or the like, or any other type of electronic device. Such an electronic device includes various types of computer readable media and interfaces for various other types of computer readable media. As shown in FIG. 12, system 1200 includes a permanent storage device 1202, a system memory 1204, an output device interface 1206, a system communications bus 1208, a read-only memory (ROM) 1210, processing unit(s) 1212, an input device interface 1214, and a network interface 1216.

Bus 1208 collectively represents all system, peripheral, and chipset buses that communicatively connect the numerous internal devices of system 1200. For instance, bus 1208 communicatively connects processing unit(s) 1212 with ROM 1210, system memory 1204, and permanent storage device 1202.

From these various memory units, processing unit(s) 1212 retrieves instructions to execute and data to process in order to execute the processes of the subject disclosure. The processing unit(s) can be a single processor or a multi-core processor in different implementations.

ROM 1210 stores static data and instructions that are needed by processing unit(s) 1212 and other modules of system 1200. Permanent storage device 1202, on the other hand, is a read-and-write memory device. This device is a non-volatile memory unit that stores instructions and data even when system 1200 is off. Some implementations of the subject disclosure use a mass-storage device (such as a magnetic or optical disk and its corresponding disk drive) as permanent storage device 1202.

Other implementations use a removable storage device (such as a floppy disk, flash drive, and its corresponding disk drive) as permanent storage device 1202. Like permanent storage device 1202, system memory 1204 is a read-and-write memory device. However, unlike storage device 1202, system memory 1204 is a volatile read-and-write memory, such as random access memory. System memory 1204 stores some of the instructions and data that the processor needs at runtime. In some implementations, the processes of the subject disclosure are stored in system memory 1204, permanent storage device 1202, and/or ROM 1210.

Bus 1208 also connects to output device interface 1206 and input device interface 1214. Input device interface 1214 enables the user to communicate information and select commands to the system 1200. Input devices used with input device interface 1214 include, for example, alphanumeric, QWERTY, or T9 keyboards, microphones, and pointing devices (also called “cursor control devices”). Output device interface 1206 enables, for example, the display of images generated by the system 1200. Output devices used with output device interface 1206 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 12, bus 1208 also couples system 1200 to a public or private network (not shown) or combination of networks through a network interface 1216. Such a network may include, for example, a local area network (“LAN”), such as an Intranet, or a wide area network (“WAN”), such as the Internet. Any or all components of system 1200 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of method 800 of FIG. 8, method 900 of FIG. 9, method 1000 of FIG. 10, and/or method 1100 of FIG. 11 as described above, may be implemented using system 1200 or any computer system having processing circuitry or a computer program product including instructions stored therein, which, when executed by at least one processor, causes the processor to perform functions relating to these methods.

As used in this specification and any claims of this application, the terms “computer,” “server,” “processor,” and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, various embodiments of a method, system, and machine-readable medium for providing a digital representation of a well schematic have been described. Embodiments of the method, system, and machine-readable medium may generally include storing a set of text strings and a set of image regions into a coordinate map; associating one or more text strings of the set of text strings with one or more image regions of the set of image regions, where a text string is associated with an image region based on a context of the text string in the coordinate map; linking one or more first image regions of the set of image regions with a corresponding catalogued image stored in a component database, where the catalogued image represents a well schematic component; generating a well schematic topology in accordance with the coordinate map and the one or more catalogued images linked with the one or more first image regions; and updating the well schematic topology in accordance with one or more business rules.

For any of the foregoing embodiments, the method, system, and machine-readable medium may include any one of the following elements, alone or in combination with each other:
Any embodiment may include linking one or more first image regions of the set of image regions with a corresponding catalogued image stored in the component database by comparing one or more image regions with catalogued images stored in the component database and determining, based on the comparing, whether an image region and a catalogued image stored in the component database satisfy a correlation threshold.
Any embodiment may include an image region being linked with the catalogued image in response to a determination that the image region and the catalogued image satisfy the correlation threshold.
Any embodiment may include storing a second set of text strings into a second coordinate map; associating one or more text strings of the second set of text strings with one or more image regions of the set of image regions, where a second text string of the second set of text strings is associated with a second image region of the set of image regions based on a context of the second text string in the second coordinate map; and linking one or more second image regions of the set of image regions with a corresponding catalogued image stored in the component database, where generating the well schematic topology further includes generating the well schematic topology in accordance with the one or more catalogued images linked with the one or more second image regions and the second coordinate map.
Any embodiment may include storing a second set of image regions into a second coordinate map; associating one or more text strings of the set of text strings with one or more image regions of the second set of image regions, where a second text string of the set of text strings is associated with a second image region of the second set of image regions based on a context of the second text string in the coordinate map; and linking one or more second image regions of the second set of image regions with a corresponding catalogued image stored in the component database, where generating the well schematic topology includes generating the well schematic topology in accordance with the one or more catalogued images linked with the one or more second image regions and the second coordinate map.
Any embodiment may include parsing a source document including the set of text strings and the set of image regions; extracting the parsed set of text strings and set of image regions from the source document; and partitioning the source document in accordance with a grid, where the partitioned source document is the coordinate map.
Any embodiment may include determining a distance between one or more text strings and one or more image regions in the coordinate map, where the context includes a distance between the text string and the image region in the coordinate map.
Any embodiment may include updating the well schematic topology by sorting the set of image regions into an order that is based on a design sequence for building a well; and updating the well schematic topology based on the sorted set of image regions.
Any embodiment may include updating the well schematic topology by determining whether a subset of image regions includes a first set of design components that satisfies a design threshold; in response to a determination that the first set of design components does not satisfy the design threshold, determining a second set of design components missing from the subset of image regions; and
updating the well schematic topology by adding the second set of design components to the well schematic topology.
Any embodiment may include updating the well schematic topology by linking a well schematic component in the well schematic topology to product data about the well schematic component; and updating the well schematic topology by providing a reference to the product data in the updated well schematic topology.
Any embodiment may include updating the well schematic topology by linking a well schematic component in the well schematic topology to product data about the well schematic component; and updating the well schematic topology by providing the product data in the updated well schematic topology.

Furthermore, the exemplary methodologies described herein may be implemented by a system including processing circuitry or a computer program product including instructions which, when executed by at least one processor, causes at least one of the processors to perform any of the methodology described herein.

Although various embodiments and methods have been shown and described, the disclosure is not limited to such embodiments and methodologies and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

1. A method of providing a digital representation of a well schematic, comprising:
storing a set of text strings and a set of image regions into a coordinate map;
associating one or more text strings of the set of text strings with one or more image regions of the set of image regions, wherein a text string is associated with an image region based on a context of the text string in the coordinate map;
linking one or more first image regions of the set of image regions with a corresponding catalogued image stored in a component database, wherein the catalogued image represents a well schematic component;
generating a well schematic topology in accordance with the coordinate map and the one or more catalogued images linked with the one or more first image regions; and
updating the well schematic topology in accordance with one or more business rules.

2. The method of claim 1, wherein linking one or more first image regions of the set of image regions with a corresponding catalogued image stored in the component database further comprises:
comparing one or more image regions with catalogued images stored in the component database; and
determining, based on the comparing, whether an image region and a catalogued image stored in the component database satisfy a correlation threshold.

3. The method of claim 2, wherein the image region is linked with the catalogued image in response to a determination that the image region and the catalogued image satisfy the correlation threshold.

4. The method of claim 1, further comprising:
storing a second set of text strings into a second coordinate map;
associating one or more text strings of the second set of text strings with one or more image regions of the set of image regions, wherein a second text string of the second set of text strings is associated with a second image region of the set of image regions based on a context of the second text string in the second coordinate map; and
linking one or more second image regions of the set of image regions with a corresponding catalogued image stored in the component database, wherein generating the well schematic topology further comprises generating the well schematic topology in accordance with the one or more catalogued images linked with the one or more second image regions and the second coordinate map.

5. The method of claim 1, further comprising:
storing a second set of image regions into a second coordinate map;
associating one or more text strings of the set of text strings with one or more image regions of the second set of image regions, wherein a second text string of the set of text strings is associated with a second image region of the second set of image regions based on a context of the second text string in the coordinate map; and
linking one or more second image regions of the second set of image regions with a corresponding catalogued image stored in the component database, wherein generating the well schematic topology includes generating the well schematic topology in accordance with the one or more catalogued images linked with the one or more second image regions and the second coordinate map.

6. The method of claim 5, further comprising:
storing a second set of text strings into the second coordinate map;
associating one or more text strings of the second set of text strings with one or more image regions of the set of image regions, wherein a second text string of the second set of text strings is associated with a second image region of the set of image regions based on a context of the second text string in the second coordinate map; and
linking one or more second image regions of the set of image regions with a corresponding catalogued image stored in the component database, wherein generating the well schematic topology further comprises generating the well schematic topology in accordance with the one or more catalogued images linked with the one or more second image regions and the second coordinate map.

7. The method of claim 1, further comprising:
parsing a source document including the set of text strings and the set of image regions;
extracting the parsed set of text strings and set of image regions from the source document; and
partitioning the source document in accordance with a grid, wherein the partitioned source document is the coordinate map.

8. The method of claim 1, further comprising:
determining a distance between one or more text strings and one or more image regions in the coordinate map, wherein the context comprises a distance between the text string and the image region in the coordinate map.

9. The method of claim 1, wherein updating the well schematic topology further comprises:
sorting the set of image regions into an order that is based on a design sequence for building a well; and
updating the well schematic topology based on the sorted set of image regions.

10. The method of claim 1, wherein updating the well schematic topology further comprises:
determining whether a subset of image regions includes a first set of design components that satisfies a design threshold;
in response to a determination that the first set of design components does not satisfy the design threshold, determining a second set of design components missing from the subset of image regions; and
updating the well schematic topology by adding the second set of design components to the well schematic topology.

11. The method of claim 1, wherein updating the well schematic topology further comprises:
linking a well schematic component in the well schematic topology to product data about the well schematic component; and
updating the well schematic topology by providing a reference to the product data in the updated well schematic topology.

12. The method of claim 1, wherein updating the well schematic topology further comprises:
linking a well schematic component in the well schematic topology to product data about the well schematic component; and
updating the well schematic topology by providing the product data in the updated well schematic topology.

13. A system for providing a digital representation of a well schematic, comprising:
a memory that stores a coordinate map including one or more text strings of a set of text strings; and
one or more processors in communication with the memory and operable to cause the system to:
store a set of text strings and a set of image regions into a coordinate map;
associate one or more text strings of the set of text strings with one or more image regions of the set of image regions, wherein a text string is associated with an image region based on a context of the text string in the coordinate map;
link one or more first image regions of the set of image regions with a corresponding catalogued image stored in a component database, wherein the catalogued image represents a well schematic component;
generate a well schematic topology in accordance with the coordinate map and the one or more catalogued images linked with the one or more first image regions; and
update the well schematic topology in accordance with one or more business rules.

14. The system of claim 13, wherein the one or more processors are further operable to cause the system to:
compare one or more image regions with catalogued images stored in the component database; and
determine, based on the comparing, whether an image region and a catalogued image stored in the component database satisfy a correlation threshold.

15. The system of claim 14, wherein the image region is linked with the catalogued image in response to a determination that the image region and the catalogued image satisfy the correlation threshold.

16. The system of claim 13, wherein the well schematic topology is generated in accordance with a second coordinate map.

17. The system of claim 13, wherein the one or more processors are further operable to cause the system to:
determine a distance between one or more text strings and one or more image regions in the coordinate map, wherein the context comprises a distance between the text string and the image region in the coordinate map.

18. The system of claim 13, wherein the one or more processors are further operable to cause the system to:
sort the set of image regions into an order that is based on a design sequence for building a well; and
update the well schematic topology based on the sorted set of image regions.

19. The system of claim 13, wherein the one or more processors are further operable to cause the system to:
determine whether a subset of image regions includes a first set of design components that satisfies a design threshold;
in response to a determination that the first set of design components does not satisfy the design threshold, determine a second set of design components missing from the subset of image regions; and
update the well schematic topology by adding the second set of design components to the well schematic topology.

20. A machine-readable medium comprising a plurality of machine-readable instructions that when executed by one or more processors are adapted to cause the one or more processors to perform a method comprising:
storing a set of text strings and a set of image regions into a coordinate map;
associating one or more text strings of the set of text strings with one or more image regions of the set of image regions, wherein a text string is associated with an image region based on a context of the text string in the coordinate map;
linking one or more first image regions of the set of image regions with a corresponding catalogued image stored in a component database, wherein the catalogued image represents a well schematic component;
generating a well schematic topology in accordance with the coordinate map and the one or more catalogued images linked with the one or more first image regions; and
updating the well schematic topology in accordance with one or more business rules.
